(19) United States
(12) Patent Application Publication
(10) Pub. No.: US 2026/0114704 A1
(43) Pub. Date: Apr. 30, 2026

(54) DISHWASHER VERTICAL PLUNGER DOOR OPEN SYSTEM

(71) Applicant: WHIRLPOOL CORPORATION, BENTON HARBOR, MI (US)

(72) Inventors: SHIVAYOGI ANNIGERI, PUNE (IN); PHILIP J. CZARNECKI, SAUGATUCK, MI (US); DAVID P. GOSHGARIAN, ST. JOSEPH, MI (US); THOMAS M. O'BRIEN, ST. JOSEPH, MI (US); ASHISH ANNASAHEB SARWADE, DHARASHIV (IN); RANIT THAPLIYAL, PUNE (IN)

(73) Assignee: WHIRLPOOL CORPORATION, BENTON HARBOR, MI (US)

(21) Appl. No.: 18/933,247

(22) Filed: Oct. 31, 2024

(51) Int. Cl. A47L 15/42; E05B 51/00; E05B 65/00

(52) U.S. Cl. CPC A47L 15/4259; E05B 51/00; E05B 65/00; A47L 2501/22

(57) ABSTRACT

A wax motor is positioned inside the dishwasher. The wax motor moves a strike away from the upper wall of the dishwasher to open the dishwasher door. The wax motor can be activated at the end of a drying cycle to automatically open the door to permit ambient air to assist in drying the dishes and to release humidity that remains in the dishwasher.

### BACKGROUND OF THE DISCLOSURE

The present disclosure generally relates to a dishwasher and, more specifically, to a mechanism for opening the door of the dishwasher. Dishes can remain moist at the end of a wash cycle. The heating used to dry the dishes can result in humidity inside the dishwasher. Thus, a device that automatically opens the dishwasher door at the end of the wash cycle, removing that humidity and allowing ambient air outside of the dishwasher to help dry the dishes would be advantageous.

### SUMMARY OF THE DISCLOSURE

One aspect of the present disclosure is a dishwasher with a door latch mechanism. The dishwasher has a dishwasher compartment with a top wall. The dishwasher door has an internal compartment with a top surface. A wax motor or any linear actuator is positioned inside the internal compartment of the door. A strike is positioned adjacent to the top surface. The strike extends into the top wall to keep the door closed when the strike is in a first position and the strike is withdrawn from the top wall to permit the door to open when the strike is in a second position. The wax motor engages the strike to move the strike from the first position to the second position.

Another aspect of the present disclosure is a dishwasher with a door latch mechanism. The dishwasher has a dishwasher compartment including a top wall with a latch. The dishwasher has a door with an internal compartment. A wax motor is positioned inside the internal compartment. A strike is positioned adjacent to the top surface of the internal compartment, wherein the strike extends to the latch to keep the door closed when the strike is in a first position and the strike is withdrawn from the latch to permit the door to open when the strike is in a second position. The wax motor engages the strike in-line to move the strike from the first position to the second position.

Another aspect of the present disclosure is a door latch mechanism for a dishwasher. A latch is coupled to the top wall of a dishwasher compartment. A wax motor is positioned inside an internal compartment of the dishwasher door. A strike is positioned adjacent to a top surface of the door, wherein the strike extends into the latch to keep the door closed when the strike is in a first position and the strike is withdrawn from the latch to permit the door to open when the strike is in a second position. The wax motor engages the strike to move the strike from the first position to the second position.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a partial front view of an embodiment of a wax motor door opening assembly;

FIG. 2 is a front view of an embodiment of the wax motor, strike, and latch components of a wax motor door opening assembly;

FIG. 2A is a front view of another embodiment of the wax motor, strike, and latch components of a wax motor door opening assembly;

FIG. 3 is a cross-sectional view of the assembly shown in FIG. 2 taken along line III-III;

FIG. 3A is a cross-sectional view of the assembly shown in FIG. 2A taken along line IIIA-IIIA;

FIG. 4 is a front view of the assembly shown in FIG. 2A with the strike in a disengaged position;

FIG. 5 is a cross-sectional view of the assembly shown in FIG. 4 taken along line V-V;

FIG. 6 is a front view of another embodiment of the wax motor, strike, and latch components of a wax motor door opening assembly;

FIG. 7 is a cross-sectional view of the assembly shown in FIG. 6 taken along line VII-VII;

FIG. 8 is a side view of another embodiment of the wax motor, strike, and catch components of a wax motor door opening assembly;

FIG. 9 is a cross-sectional view of the assembly shown in FIG. 8 taken along line IX-IX;

FIG. 10 is a side view of the assembly shown in FIG. 8 with the strike in a disengaged position;

FIG. 11 is cross-sectional view of the assembly shown in FIG. 10 taken along line XI-XI;

FIG. 12 is a top perspective view of another embodiment of a wax motor door opening assembly;

FIG. 13 is a top view of the wax motor door opening assembly shown in FIG. 12;

FIG. 14 is a side cross-sectional view of the wax motor door opening assembly of FIG. 12 with the strike engaged; and

FIG. 15 is a side cross-sectional view of the wax motor door opening assembly of FIG. 12 with the strike disengaged.

The components in the figures are not necessarily to scale, emphasis instead being placed upon illustrating the principles described herein.

### DETAILED DESCRIPTION

The present illustrated embodiments reside primarily in combinations of method steps and apparatus components related to a mechanism for opening the door of a dishwasher. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

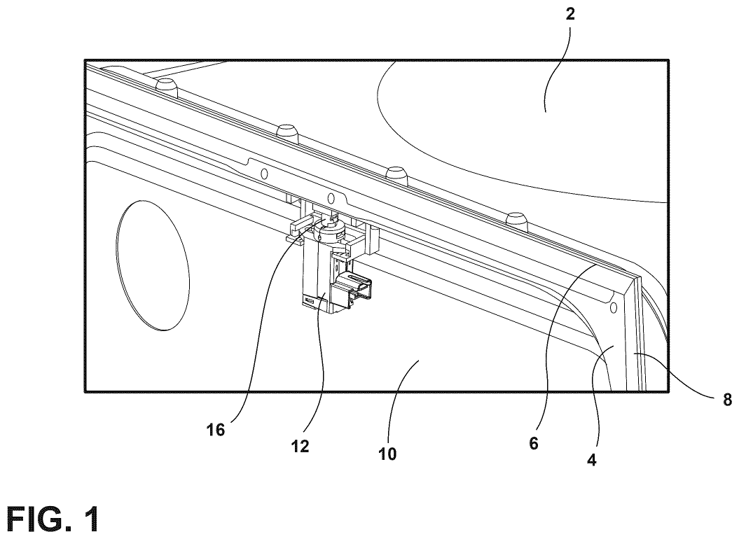

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

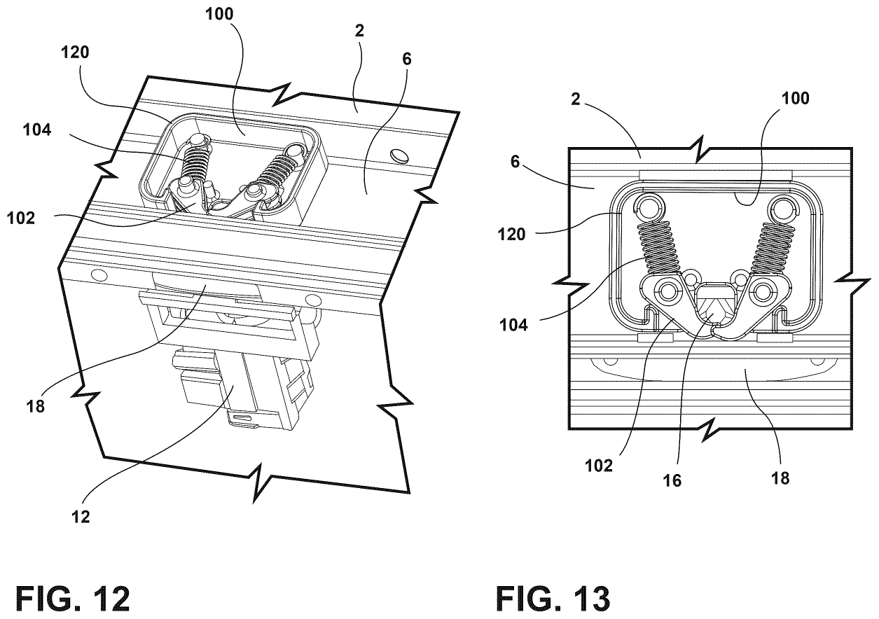

Referring to FIGS. 1 and 12, reference numeral 2 refers to a dishwasher. The dishwasher 2 has a washing compartment for washing dishes that is enclosed by the rear surface 8 of a door 4. The washing compartment has a top wall 6. The door 4 includes an internal compartment 10 that is positioned between the front surface and rear surface 8 of the door 4.

A wax motor 12 is positioned within the internal compartment 10 of the door 4. The wax motor 12 includes a plunger 22 that retracts into the wax motor 12 when the wax within the wax motor 12 is heated and expands. When the heat source is removed, the wax will cool and contract causing the plunger 22 to return to its extended position. While the illustrated embodiments show use of a wax motor 12, another linear actuator could be used.

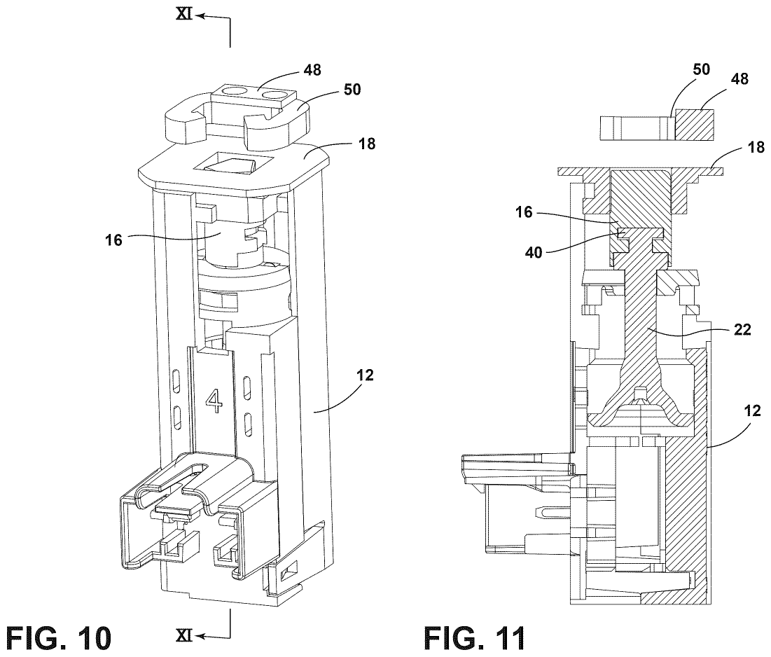

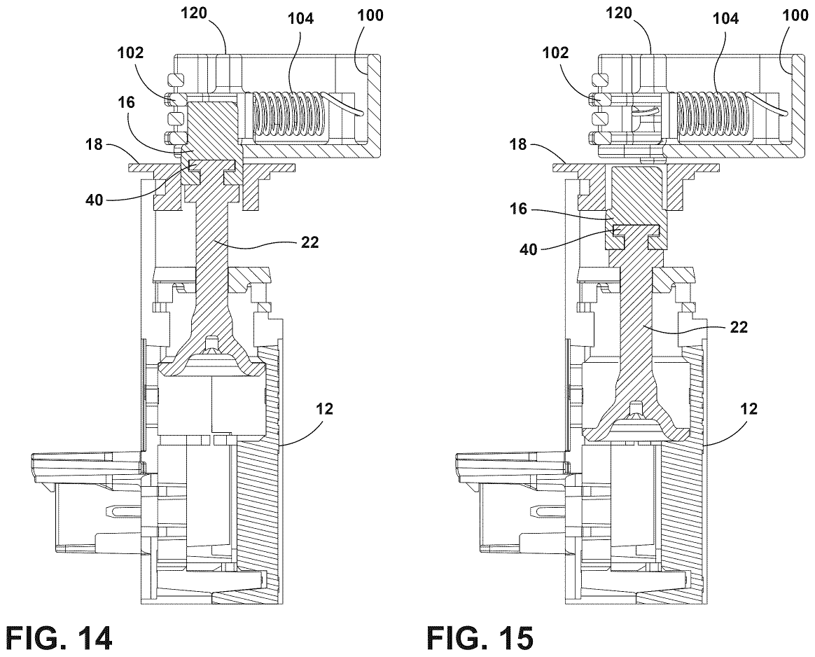

In FIGS. 1-15, the wax motor 12 is illustrated as being positioned in-line with a strike 16 that can be raised and lowered by the plunger 22 of the wax motor 12. The strike 16 can be coupled to the plunger 22. Alternatively, the plunger 22 can rotate to engage or disengage the strike 16. The plunger 22 can have a shoulder 40 that is received in the strike 16. The wax motor 12 could be offset from the strike 16 and/or could be coupled to the strike 16 in alternative ways.

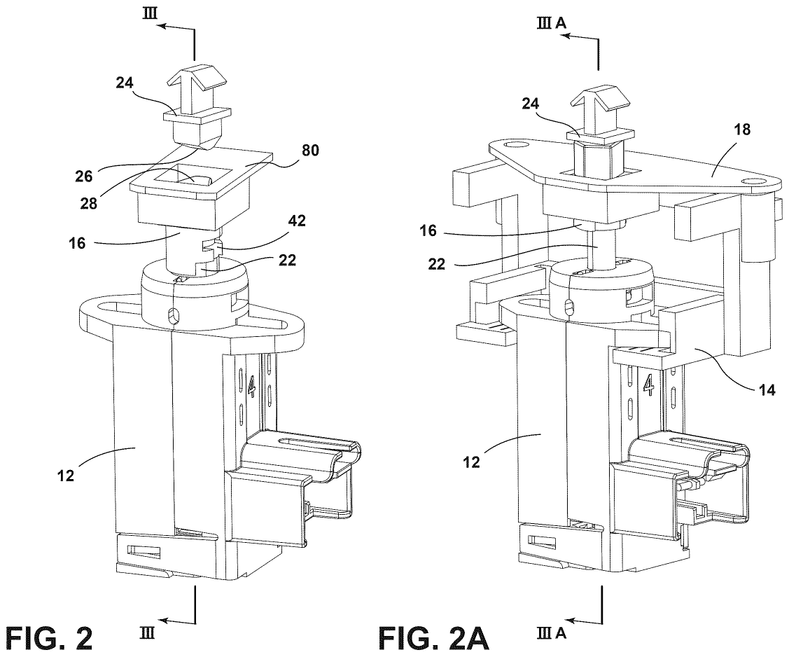

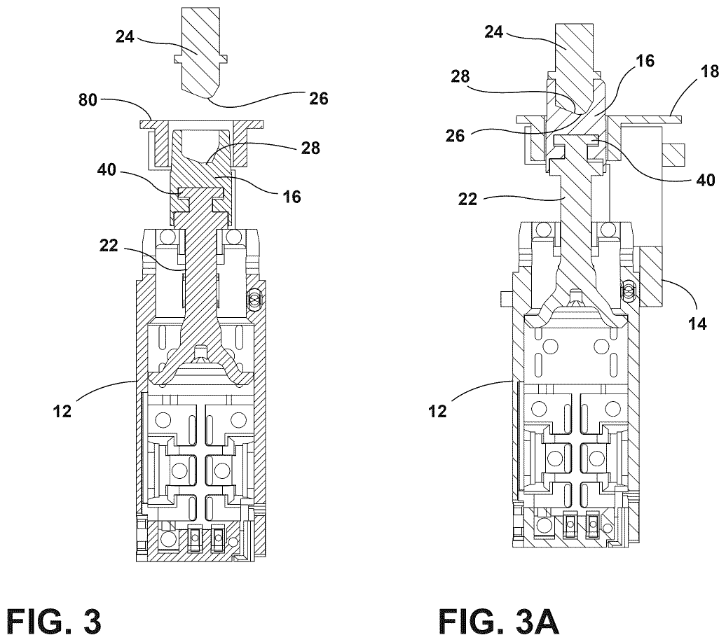

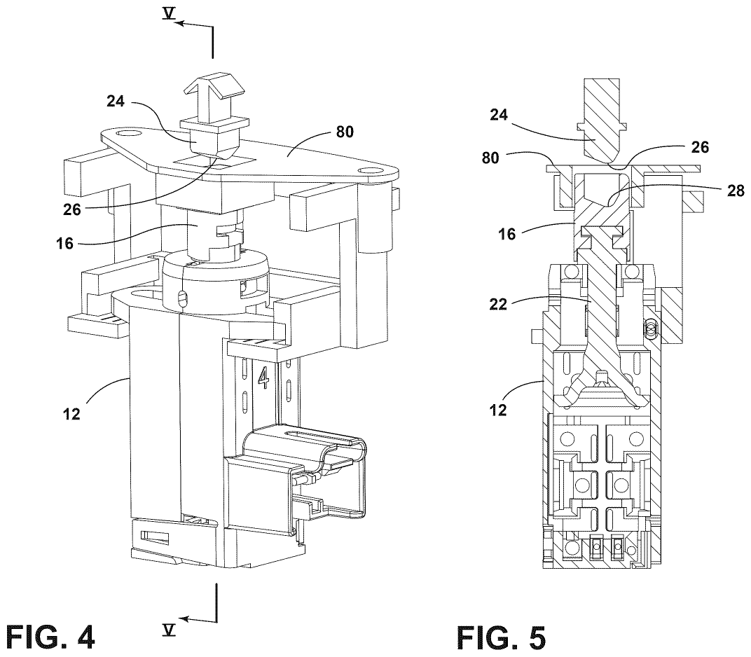

The strike 16 can engage/disengage the top wall 6 of the dishwasher 2 to open and close the door 4. In the embodiment shown in FIGS. 1, 2, 2A, 3, 3A, 4, and 5, the strike 16 engages a latch 24 that is positioned in the top wall 6. The strike 16 can have a contour 28 that receives a portion 26 of the latch 24 to help secure the contact between the strike 16 and the latch 24. FIGS. 2A and 3A illustrate the strike 16 in a position where it is engaged with the latch 24 resulting in the door 4 remaining closed. FIGS. 4 and 5 illustrate the plunger 22 being activated to contract within the wax motor 12 resulting in the strike 16 being disengaged from the latch 24. This permits the door 4 to open. A bezel 18 can be used to take up the gap between the top surface of the door 4 and the plunger 22. The bezel 18 can also act as a guide for the strike 16. A bracket 14 may be used to support the wax motor 12 and/or the bezel 18 with the internal compartment 10 of door 4.

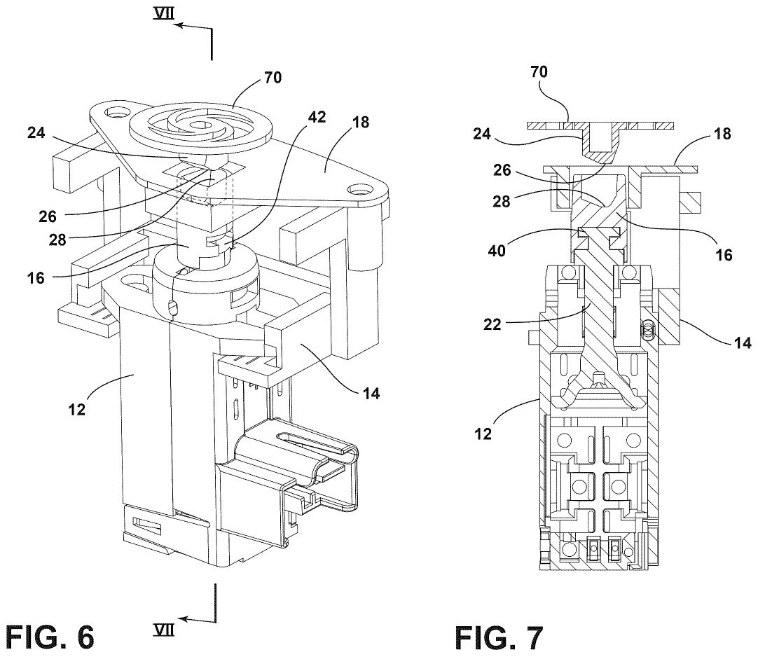

Another embodiment, shown in FIGS. 2 and 3, utilizes a differently shaped bezel 80 and differently shaped strike 16. The embodiment shown in FIGS. 6 and 7 utilizes a differently shaped latch 24 that has a shoulder 70. In the embodiments shown in FIGS. 1-7, the latch 24 is coupled inside the top wall 6 of the dishwasher 2. This coupling can be done mechanically, such as with tabs, or can be done in other ways.

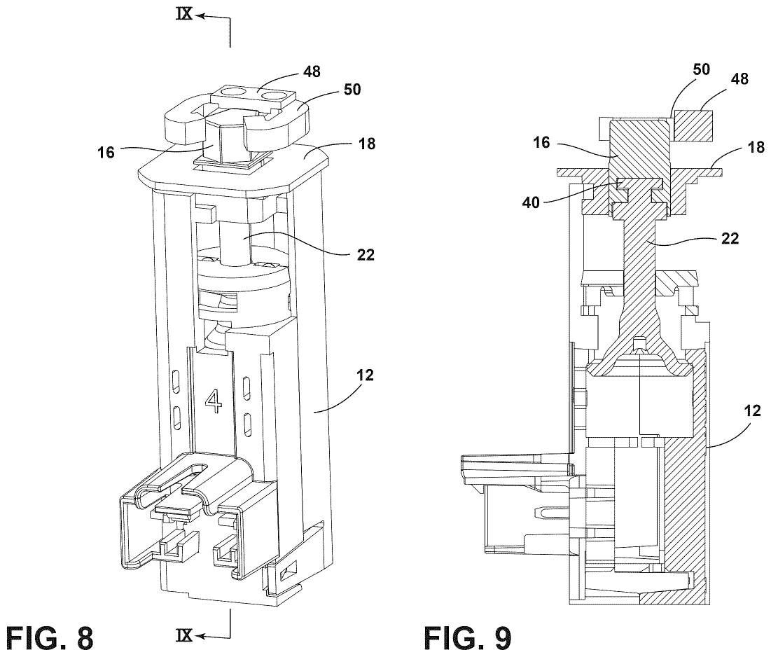

FIGS. 8-11 illustrate the use of a catch 48 that is positioned within the top wall 6 of the dishwasher 2. The catch 48 can include arms 50 that catch the strike 16 to hold the door 4 shut. When the wax motor 12 is activated, the plunger 22 will pull the strike 16 downward to release it from the catch 48 to open the door 4. The catch 48 can be a molded piece of plastic.

A mechanical latch/catch system 100 can be positioned in the top wall 6 of the dishwasher 2 as shown in FIGS. 12-15. The mechanical latch system 100 can be positioned in a housing 120 and can include springs 104 with arms 102 that engage strike 16. Again, the strike 16 can be withdrawn from the mechanical latch system 200 when the plunger 22 is activated in wax motor 12, as illustrated in FIG. 15.

The wax motor 12 can be activated after the drying cycle is done to open the door 4 of the dishwasher to assist in drying the dishes. The wax motor 12 can also be deactivated when the door 4 is shut in order to lock the door 4. When the door 4 is unlocked, the door 4 can open a few inches until the springs on the hinges of the door 4 are engaged.

While the wax motor 12 is shown installed in the door 4, the wax motor 12 and strike 16 could be installed in a wall of dishwasher 2. In such an arrangement, the latch 24 or catch 48 would be arranged on the door 4. This would also allow the wax motor 12 to be activated to unlock the door 4.

According to another aspect of the present disclosure is a dishwasher with a door latch mechanism. The dishwasher has a dishwasher compartment including a top wall, a door including an internal compartment with a top surface, and a wax motor positioned inside said internal compartment. A strike is positioned adjacent to said top surface, wherein said strike extends into said top wall to keep said door closed when said strike is in a first position and said strike is withdrawn from said top wall to permit said door to open when said strike is in a second position. A wax motor engages said strike to move said strike from said first position to said second position.

According to another aspect, dishwasher includes a wax motor positioned in-line with said strike.

According to another aspect, the dishwasher includes a latch in said top wall, said latch including a shaped catch member that engages a portion of said strike.

According to another aspect, the catch member is one piece.

According to another aspect, the catch member is plastic with spaced apart arms.

According to another aspect, the catch member has spring biased arms.

According to another aspect, the wax motor is coupled to a bracket that is coupled inside said internal compartment.

According to another aspect, the strike rotates between said first position and said second position.

According to another aspect, the strike has a recess shaped to engage a latch in said top wall.

According to another aspect, is a dishwasher with a door latch mechanism. The dishwasher has a dishwasher compartment including a top wall with a latch, a door including an internal compartment with a top surface, and a wax motor positioned inside said internal compartment. A strike is positioned adjacent to said top surface, wherein said strike extends to said latch to keep said door closed when said strike is in a first position and said strike is withdrawn from said latch to permit said door to open when said strike is in a second position. The wax motor engages said strike in-line to move said strike from said first position to said second position.

According to another aspect, the latch includes a shaped catch member that engages a portion of said strike.

According to another aspect, the strike is received in spaced apart arms of said catch member.

According to another aspect, the wax motor is coupled to a bracket that is coupled inside said internal compartment.

According to another aspect, the strike rotates between said first position and said second position.

According to another aspect, is a door latch mechanism for a dishwasher. The door latch mechanism has a latch coupled to the top wall of a dishwasher compartment. A wax motor is positioned inside an internal compartment of the dishwasher door. A strike is positioned adjacent to a top surface of said door, wherein said strike extends into said latch to keep said door closed when said strike is in a first position and said strike is withdrawn from said latch to permit said door to open when said strike is in a second position. The wax motor engages said strike to move said strike from said first position to said second position.

According to another aspect, the wax motor is positioned in-line with said strike.

According to another aspect, the latch includes a shaped member that engages a portion of said strike.

According to another aspect, the latch is plastic with opposed arms.

According to another aspect, the said latch includes spring biased arms.

According to another aspect, the strike has a recess shaped to engage a portion of said latch.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A dishwasher with a door latch mechanism comprising:
a dishwasher compartment including a top wall;
a door including an internal compartment with a top surface;
a wax motor positioned inside said internal compartment;
a strike positioned adjacent to said top surface, wherein said strike extends into said top wall to keep said door closed when said strike is in a first position and said strike is withdrawn from said top wall to permit said door to open when said strike is in a second position; and
wherein said wax motor engages said strike to move said strike from said first position to said second position.

2. The dishwasher of claim 1, wherein said wax motor is positioned in-line with said strike.

3. The dishwasher of claim 1, including a latch in said top wall, said latch including a shaped catch member that engages a portion of said strike.

4. The dishwasher of claim 3, wherein said catch member is one piece.

5. The dishwasher of claim 3, wherein said catch member is plastic with spaced apart arms.

6. The dishwasher of claim 3, wherein said catch member has spring biased arms.

7. The dishwasher of claim 1, wherein the wax motor is coupled to a bracket that is coupled inside said internal compartment.

8. The dishwasher of claim 1, wherein said strike rotates between said first position and said second position.

9. The dishwasher of claim 1, wherein said strike has a recess shaped to engage a latch in said top wall.

10. A dishwasher with a door latch mechanism comprising:
a dishwasher compartment including a top wall with a latch;
a door including an internal compartment with a top surface;
a wax motor positioned inside said internal compartment;
a strike positioned adjacent to said top surface, wherein said strike extends to said latch to keep said door closed when said strike is in a first position and said strike is withdrawn from said latch to permit said door to open when said strike is in a second position; and
wherein said wax motor engages said strike in-line to move said strike from said first position to said second position.

11. The dishwasher of claim 10, wherein said latch includes a shaped catch member that engages a portion of said strike.

12. The dishwasher of claim 11, wherein said strike is received in spaced apart arms of said catch member.

13. The dishwasher of claim 10, wherein the wax motor is coupled to a bracket that is coupled inside said internal compartment.

14. The dishwasher of claim 10, wherein said strike rotates between said first position and said second position.

15. A door latch mechanism for a dishwasher comprising:
a latch coupled to a top wall of a dishwasher compartment;
a wax motor positioned inside an internal compartment of a dishwasher door;
a strike positioned adjacent to a top surface of said door, wherein said strike extends into said latch to keep said door closed when said strike is in a first position and said strike is withdrawn from said latch to permit said door to open when said strike is in a second position; and
wherein said wax motor engages said strike to move said strike from said first position to said second position.

16. The dishwasher of claim 15, wherein said wax motor is positioned in-line with said strike.

17. The dishwasher of claim 15, wherein said latch includes a shaped catch member that engages a portion of said strike.

18. The dishwasher of claim 17, wherein said latch is plastic with opposed arms.

19. The dishwasher of claim 17, wherein said latch includes spring biased arms.

20. The dishwasher of claim 15, wherein said strike has a recess shaped to engage a portion of said latch.
